(19) United States
(12) Patent Application Publication
(10) Pub. No.: US 2011/0084603 A1
(43) Pub. Date: Apr. 14, 2011

(54) INORGANIC ELECTROLUMINESCENT DEVICE AND MANUFACTURING METHOD THEREOF

(75) Inventors: Lee Mi Do, Daejeon (KR); Kun Silk Park, Daejeon (KR); Dong Pyo Kim, Gwangmyeong (KR); Ji Man Park, Daejeon (KR); Jin Yeong Kang, Daejeon (KR); Kyu Ha Baek, Daejeon (KR)

(73) Assignee: Electronics and Telecommunications Research Institute, Daejeon (KR)

(21) Appl. No.: 12/900,323

(22) Filed: Oct. 7, 2010

(30) Foreign Application Priority Data
Oct. 9, 2009 (KR) 10-2009-0096449
Oct. 5, 2010 (KR) 10-2010-0096841

(51) Int. Cl. H05B 33/02; H05B 33/10

(52) U.S. Cl. 313/512; 313/498; 445/33

(57) ABSTRACT

An inorganic electroluminescent device includes: patterned metal electrodes periodically disposed at pre-set intervals; and a phosphor layer positioned on the patterned metal electrodes, wherein as a first voltage and a second voltage are alternately applied to the patterned metal electrodes according to the order of their disposition, light emitted from the phosphor layer is discharged to the spaces between the patterned metal electrodes.

### CROSS-REFERENCE TO RELATED APPLICATIONS

This application claims the priority of Korean

Patent Application No. 10-2009-0096449 filed on Oct. 09, 2009 and Korean Patent Application No. 10-2010-0096841 filed on Oct. 05, 2010, in the Korean Intellectual Property Office, the disclosure of which is incorporated herein by reference.

### BACKGROUND OF THE INVENTION

1. Field of the Invention

The present invention relates to an inorganic electroluminescent device and a manufacturing method thereof, and more particularly, to a technique for implementing an inorganic electroluminescent device by using a patterned metal electrode, rather than using the transparent electrode, generally used for an inorganic electroluminescent device, which requires a complicated process and incurs high costs, thus simplifying the manufacturing process of the inorganic electroluminescent device and reducing a process unit cost.

2. Description of the Related Art

FIG. 1 is a sectional view of the related art inorganic electroluminescent device. The related art inorganic electroluminescent device is formed by coating a front transparent electrode 12 on a substrate 11, sequentially coating an insulating layer 13 for interrupting a flow of electrons, a phosphor layer 14 for light emission, and an insulating layer 13 for interrupting a flow of electrons, on the transparent electrode 12, coating a rear electrode 15 on the insulating layer 13, and then coating a protection layer 16 for improving durability of the inorganic electroluminescent device on the rear electrode 15. In this case, the rear electrode 15, which is made of silver (Ag) having excellent reflectivity, mainly in a visible ray area, serves to reflect an entirety of light, heading to the rear electrode 15 after being emitted from the phosphor layer 14, toward the front transparent electrode 12 and the substrate 11 made of a transparent material, thus increasing luminous efficiency.

Thus, in the related art inorganic electroluminescent device 10, the electrode positioned in the direction of the light emission for the purpose of light emission must necessarily be formed as the transparent electrode. However, the manufacturing process of the transparent electrode is complicated and a large cost may be incurred in the manufacturing process.

### SUMMARY OF THE INVENTION

An aspect of the present invention provides an inorganic electroluminescent device which can be implemented by using a patterned metal electrode, rather than using the transparent electrode, generally used for an inorganic electroluminescent device, which requires a complicated process and incurs high costs, thus simplifying the manufacturing process of the inorganic electroluminescent device and reducing a process unit cost, and a manufacturing method thereof.

According to an aspect of the present invention, there is provided an inorganic electroluminescent device including: patterned metal electrodes periodically disposed at pre-set intervals; and a phosphor layer positioned on the patterned metal electrodes, wherein as a first voltage and a second voltage are alternately applied to the patterned metal electrodes according to the order of their disposition, light emitted from the phosphor layer is discharged to spaces between the patterned metal electrodes.

Light emitted from the phosphor layer may be controlled according to the space (gap or interval) between the patterned metal electrodes, and the space between the patterned metal electrodes may range from 0.01 um to 300 um.

An opening having a predetermined shape may be formed between the patterned metal electrodes to allow light emitted from the phosphor layer to be transmitted in the shape of the opening.

According to another aspect of the present invention, there is provided an inorganic electroluminescent device including: a substrate; patterned metal electrodes coated on the substrate and periodically disposed at pre-set intervals; an insulating layer coated on the substrate and the patterned metal electrodes to interrupt a flow of electrons; a phosphor layer coated on the insulating layer and emitting light by an electric field applied to the patterned metal electrodes; and a protection layer coated on the phosphor layer to protect the inorganic electroluminescent device.

As a first voltage and a second voltage are alternately applied to the patterned metal electrodes according to the order of their disposition, light emitted from the phosphor layer may be discharged to the spaces between the patterned metal electrodes.

The inorganic electroluminescent device may further include: a mirror face coated between the phosphor layer and the protection layer to reflect light emitted from the phosphor layer. In this case, the substrate may be formed as a transparent substrate.

The inorganic electroluminescent device may further include: a mirror face coated between the substrate and the patterned metal electrodes to reflect light emitted from the phosphor layer. In this case, the protection layer may be made of a transparent material.

According to another aspect of the present invention, there is provided a method for manufacturing an inorganic electroluminescent device, including: forming patterned metal electrodes on a substrate such that they are periodically disposed at pre-set intervals; forming an insulating layer for interrupting a flow of electrodes on the substrate and the patterned metal electrodes; forming a phosphor layer on the insulating layer; and forming a protection layer on the phosphor layer to protect the inorganic electroluminescent device.

The method may further include: forming an opening having a predetermined shape between the patterned metal electrodes; forming a mirror face on the phosphor layer to reflect light emitted from the phosphor layer; and forming a mirror face on the substrate to reflect light emitted from the phosphor layer.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a sectional view of the related art inorganic electroluminescent device;

FIG. 2 is a sectional view of an inorganic electroluminescent device according to an exemplary embodiment of the present invention;

FIG. 3 is a sectional view of a bi-planar light emission type inorganic electroluminescent device according to an exemplary embodiment of the present invention; and

FIG. 4 is a sectional view of a uni-planar light emission type inorganic electroluminescent device according to an exemplary embodiment of the present invention.

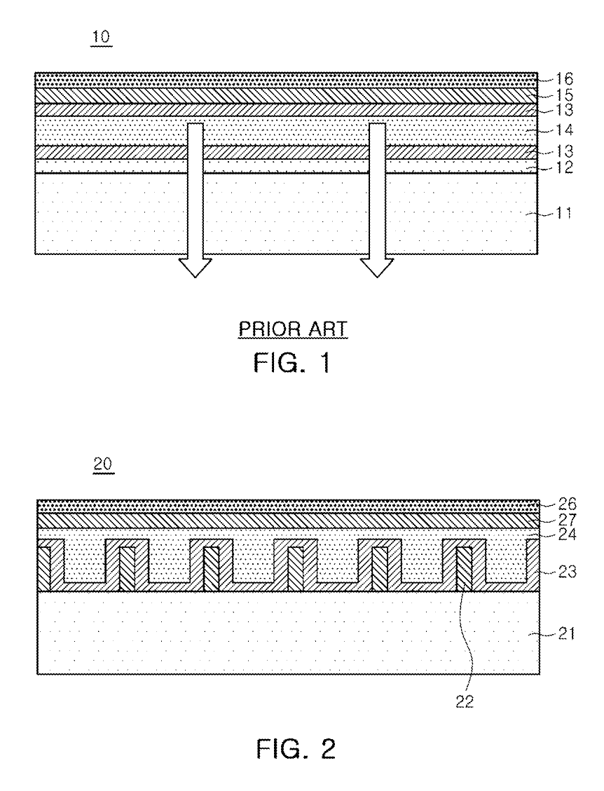

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions may be exaggerated for clarity, and the same reference numerals will be used throughout to designate the same or like components.

It will be understood that when an element is referred to as being “connected with” another element, it can be directly connected with the other element or intervening elements may also be present. In contrast, when an element is referred to as being “directly connected with” another element, there are no intervening elements present. In addition, unless explicitly described to the contrary, the word “comprise” and variations such as “comprises” or “comprising,” will be understood to imply the inclusion of stated elements but not the exclusion of any other elements.

FIG. 2 is a sectional view of an inorganic electroluminescent device according to an exemplary embodiment of the present invention. As shown in FIG. 2, the inorganic electroluminescent device has a structure in which a substrate 21, patterned metal electrodes 22, an insulating layer 23, a phosphor layer 24, a mirror face 27, and a protection layer 26 are sequentially laminated or stacked.

The structure and a manufacturing process of the inorganic electroluminescent device will now be described in detail. First, the patterned metal electrodes 22 are formed on the substrate 211. The patterned metal electrodes 22 may be generally used metal electrodes, rather than transparent electrodes, and periodically disposed at certain intervals. At this time, emitted light is controlled according to the space between the patterned metal electrodes 22, and in this case, preferably, the space between the patterned metal electrodes 22 may be adjusted to maximize luminous efficiency. An opening having a linear, circular, quadrangular shape, or the like, may be formed between the patterned metal electrodes 22 to allow light emitted from the phosphor layer 24 to be transmitted in a linear, circular, quadrangular shape, or the like.

Thereafter, the insulating layer 23 is coated on the substrate 21 and the patterned metal electrodes 22 to interrupt a flow of electrons, and the phosphor layer 24 for emitting light, the mirror face 27 for reflecting light, and the protection layer 26 for protecting the device are sequentially coated on the substrate 21 and the patterned metal electrodes 22.

The mirror face 27 serves to reflect light, which goes upward after being emitted from the phosphor layer 24, toward the rear surface. The mirror face 27 may be made of a material having a high reflectivity regardless of electrical resistance.

The protection layer 26 serves to block moisture or an external influence to thus protect the inorganic electroluminescent device. The substrate 21, the insulating layer 23, the phosphor layer 24, and the protection layer may be made of the same material as that of the related art inorganic electroluminescent device, so a detailed description thereof will be omitted.

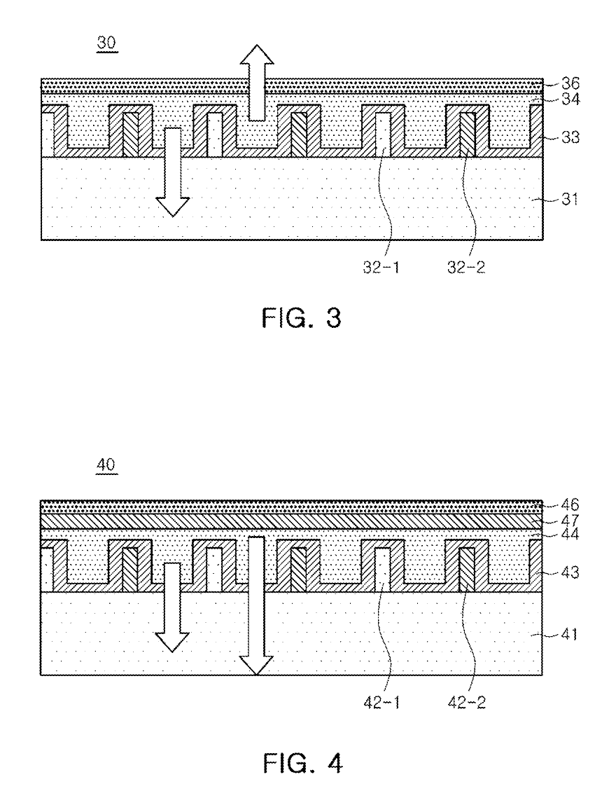

FIG. 3 is a sectional view of a bi-planar light emission type inorganic electroluminescent device according to an exemplary embodiment of the present invention. As shown in FIG. 3, the bi-planar light emission type inorganic electroluminescent device has a structure in which a substrate 31, patterned metal electrodes 32-1 and 32-2, an insulating layer 33, a phosphor layer 34, and a protection layer 36 are sequentially stacked. Namely, the bi-planar light emission type inorganic electroluminescent device according to the present exemplary embodiment does not have the mirror face 27 of the inorganic electroluminescent device illustrated in FIG. 2.

As shown in FIG. 3, when a first voltage and a second voltage are alternately applied to the patterned metal electrodes 32-1 and 32-2 according to the order of their disposition, light is discharged from both sides from between the patterned metal electrodes according to light emission, thus implementing the bi-planar light emission type inorganic electroluminescent device. To this end, the protection layer 26 must be made of a transparent material.

FIG. 4 is a sectional view of a uni-planar light emission type inorganic electroluminescent device according to an exemplary embodiment of the present invention. As shown in FIG. 4, the uni-planar light emission type inorganic electroluminescent device includes a substrate 41, patterned metal electrodes 42-1 and 42-2, an insulating layer 43, a phosphor layer 44, a mirror face 47, and a protection layer 46 are sequentially stacked. Namely, the uni-planar light emission type inorganic electroluminescent device has the same structure as that of the inorganic electroluminescent device illustrated in FIG. 2.

As shown in FIG. 4, when a first voltage and a second voltage are alternately applied to the patterned metal electrodes 42-1 and 42-2 according to the order of their disposition, light is discharged from both sides from between the patterned metal electrodes according to light emission. At this time, light, which goes toward the protection layer 46, is reflected by the mirror face 47 so as to be discharged only to the substrate 41 made of a transparent material, thus implementing the highly efficient uni-planar light emission type inorganic electroluminescent device.

In the present exemplary embodiment, the mirror face 47 is coated on the phosphor layer 44. However, without being limited thereto, the mirror face 47 may be positioned under the patterned metal electrodes 42-1 and 42-2 to reverse the direction of light emission. In this case, the protection layer 46 must necessarily be made of a transparent material.

As set forth above, according to exemplary embodiments of the invention, because the inorganic electroluminescent device is implemented by using a patterned metal electrode, rather than using the transparent electrode, generally used for an inorganic electroluminescent device, which requires a complicated manufacturing process and incurs high costs therein, the manufacturing process of the inorganic electroluminescent device can be simplified and the process unit cost thereof can be reduced.

Also, because the inorganic electroluminescent device has a simpler electrode structure than that of the related art inorganic electroluminescent device including a transparent electrode and a rear electrode, the reliability of the operation of the inorganic electroluminescent device can be improved.

In addition, luminous efficiency (or out-coupling) can be maximized when light emitted from a phosphor layer passes between the patterned metal electrodes by adjusting the space between the patterned metal electrodes.

While the present invention has been shown and described in connection with the exemplary embodiments, it will be apparent to those skilled in the art that modifications and variations can be made without departing from the spirit and scope of the invention as defined by the appended claims.

What is claimed is:

1. An inorganic electroluminescent device comprising:
patterned metal electrodes periodically disposed at pre-set intervals; and
a phosphor layer positioned on the patterned metal electrodes,
wherein as a first voltage and a second voltage are alternately applied to the patterned metal electrodes according to the order of their disposition, light emitted from the phosphor layer is discharged to the spaces between the patterned metal electrodes.

2. The device of claim 1, wherein light emitted from the phosphor layer is controlled according to the space between the patterned metal electrodes.

3. The device of claim 2, wherein the space between the patterned metal electrodes ranges from 0.01 um to 300 um.

4. The device of claim 1, wherein an opening having a predetermined shape is formed between the patterned metal electrodes to allow light emitted from the phosphor layer to be transmitted in the shape of the opening.

5. An inorganic electroluminescent device comprising:
a substrate;
patterned metal electrodes coated on the substrate and periodically disposed at pre-set intervals;
an insulating layer coated on the substrate and the patterned metal electrodes to interrupt a flow of electrons;
a phosphor layer coated on the insulating layer and emitting light by an electric field applied to the patterned metal electrodes; and
a protection layer coated on the phosphor layer to protect the inorganic electroluminescent device.

6. The device of claim 5, wherein as first voltage and a second voltage are alternately applied to the patterned metal electrodes according to the order of their disposition, light emitted from the phosphor layer is discharged to the spaces between the patterned metal electrodes.

7. The device of claim 5, further comprising: a mirror face coated between the phosphor layer and the protection layer to reflect light emitted from the phosphor layer.

8. The device of claim 7, wherein the substrate is formed as a transparent substrate.

9. The device of claim 5, further comprising: a mirror face coated between the substrate and the patterned metal electrodes to reflect light emitted from the phosphor layer.

10. The device of claim 9, wherein the protection layer is made of a transparent material.

11. The device of claim 5, wherein light emitted from the phosphor layer is controlled according to the space between the patterned metal electrodes.

12. The device of claim 11, wherein the space between the patterned metal electrodes ranges from 0.01 um to 300 um.

13. The device of claim 5, wherein an opening having a predetermined shape is formed between the patterned metal electrodes to allow light emitted from the phosphor layer be transmitted in the shape of the opening.

14. A method for manufacturing an inorganic electroluminescent device, the method comprising:
forming patterned metal electrodes on a substrate such that they are periodically disposed at pre-set intervals;
forming an insulating layer for interrupting a flow of electrodes on the substrate and the patterned metal electrodes;
forming a phosphor layer on the insulating layer; and
forming a protection layer on the phosphor layer to protect the inorganic electroluminescent device.

15. The method of claim 14, further comprising: forming an opening having a predetermined shape between the patterned metal electrodes.

16. The method of claim 14, further comprising: forming a mirror face on the phosphor layer to reflect light emitted from the phosphor layer.

17. The method of claim 14, further comprising: forming a mirror face on the substrate to reflect light emitted from the phosphor layer.
